(19) United States
(12) Patent Application Publication
(10) Pub. No.: US 2025/0180484 A1
(43) Pub. Date: Jun. 5, 2025

(54) APPARATUS AND METHOD FOR FLUORESCENCE DETECTION IN ELECTRONIC DEVICES WITH HIGH BRIGHTNESS COAXIAL DIODE LASER ILLUMINATION

(71) Applicant: Orbotech Ltd., Yavne (IL)

(72) Inventors: Ophir Eyal, Ramat Hasharon (IL); Ilia Lutsker, Kfar Saba (IL); Ofir Shnit, Yavne (IL); Oded Mor, Yavne (IL)

(21) Appl. No.: 18/529,242

(22) Filed: Dec. 5, 2023

(51) Int. Cl. G01N 21/64

(52) U.S. Cl. CPC G01N 21/6489; G01N 2201/06113; G01N 2201/0633; G01N 2201/08

(57) ABSTRACT

The system includes a laser light source configured to emit laser light; an optical fiber coupled to the laser light source and configured to guide the laser light along an illumination path; and an illumination optical assembly disposed in the illumination path and configured to direct the laser light on a workpiece. The workpiece emits fluorescent light along an emission path based on illumination from the laser light. The system further includes a collection optical assembly disposed in the emission path and configured to separate the fluorescent light from reflected laser light; and a detector disposed in the emission path and configured to generate one or more fluorescence images based on the fluorescent light.

### FIELD OF THE DISCLOSURE

This disclosure relates to inspection systems and, more particularly, to fluorescence imaging for inspection of electronic devices.

### BACKGROUND OF THE DISCLOSURE

Evolution of the electronics manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for an electronics manufacturer.

Inspection processes are used at various steps during electronics manufacturing to detect defects on wafers, electronic devices, or electrical circuits to promote higher yield in the manufacturing process and, thus, higher profits. Inspection has always been an important part of fabricating electronic devices such as integrated circuits (ICs) and printed circuit boards (PCBs), including assembled PCBs. However, as feature dimensions decrease, inspection becomes even more important to the successful manufacture of acceptable electronic devices because smaller defects can cause devices and assemblies to fail. For instance, as feature dimensions decrease, detection of defects of decreasing size has become necessary because even relatively small defects may cause unwanted aberrations in the devices.

Some inspection processes use fluorescence imaging to detect defects on PCBs. In these techniques, illumination of the PCB causes emission of fluorescent light from the substrate, and a camera can capture an image of the fluorescent light emission to identify defects on the PCB. Existing systems typically use LEDs to illuminate the PCB. Unless the LEDs are angled relative to the substrate, there may be strong reflection by copper or other reflective surfaces on the substrate toward the camera. However, this results in reduced illumination intensity and inefficient diffuse illumination of the substrate between high aspect ratio (HAR) structures on the PCB, and image contrast is reduced based on poor activation for fluorescent emission in these areas.

Therefore, what is needed is an improved fluorescence generation and detection process that is suited for PCBs having HAR structures.

### BRIEF SUMMARY OF THE DISCLOSURE

An embodiment of the present disclosure provides a system. The system may comprise a laser light source configured to emit laser light; an optical fiber coupled to the laser light source and configured to guide the laser light along an illumination path; and an illumination optical assembly disposed in the illumination path and configured to direct the laser light on a workpiece. The workpiece may emit fluorescent light along an emission path based on illumination from the laser light.

The system may further comprise a collection optical assembly disposed in the emission path and configured to separate the fluorescent light from reflected laser light; and a detector disposed in the emission path and configured to generate one or more fluorescence images based on the fluorescent light.

In some embodiments, the illumination from the laser light may be perpendicular to the workpiece.

In some embodiments, the laser light source may have a power of 1 mW to 500 W.

In some embodiments, the laser light source may be a first laser light source. The system may further comprise a second laser light source configured to emit laser light having at least one different wavelength and a different polarization from the first laser light source; and a fiber coupler configured to combine the laser light from the first laser light source and the laser light from the second laser light source in a single optical fiber along a common illumination path.

In some embodiments, the optical fiber may comprise a plurality of optical fibers. Each optical fiber may be configured to guide the laser light along separate illumination paths, and the illumination optical assembly may be configured to direct the laser light in each of the separate illumination paths to illuminate separate areas of the workpiece.

In some embodiments, the optical fiber may be a non-circular optical fiber.

In some embodiments, the illumination optical assembly may comprise a collimation lens configured to collimate the laser light in the illumination path; a homogenizer configured to homogenize the laser light in the illumination path; and an objective lens configured to direct the laser light onto the workpiece.

In some embodiments, the collection optical assembly may comprise a beam splitter disposed in the emission path and configured to direct the fluorescent light toward the detector and direct the reflected laser light away from the detector.

In some embodiments, the collection optical assembly may comprise a spectral filter disposed in the emission path and configured to transmit one or more wavelength bands corresponding to the fluorescent light and block one or more wavelength bands corresponding to the reflected laser light.

In some embodiments, the laser light may have a wavelength of 350 nm to 450 nm.

In some embodiments, the fluorescent light may have a wavelength of 400 nm to 650 nm.

In some embodiments, the workpiece may be a substrate comprising one or more structures having an aspect ratio greater than 1:1.

In some embodiments, the laser light source may be spatially separated from the illumination optical assembly by the optical fiber.

Another embodiment of the present disclosure provides a method comprising: emitting laser light from a laser light source; guiding the laser light along an illumination path with an optical fiber coupled to the laser light source; directing the laser light on a workpiece with an illumination optical assembly; emitting fluorescent light from the workpiece along an emission path based on illumination from the laser light; separating the fluorescent light from reflected laser light in the emission path with a collection optical assembly; and generating one or more fluorescence images based on the fluorescent light received by a detector.

In some embodiments, emitting laser light from the laser light source may comprise emitting laser light from a first laser light source; and emitting laser light from a second laser light source having at least one different wavelength and a different polarization from the first laser light source.

In some embodiments, guiding the laser light along the illumination path with the optical fiber coupled to the laser light source may comprise: guiding the laser light from the first laser light source with a first optical fiber coupled to the first laser light source; guiding the laser light from the second laser light source with a second optical fiber coupled to the second laser light source; and combining the laser light from the first laser light source of the first optical fiber and the laser light from the second laser light source of the second optical fiber in a single optical fiber along a common illumination path with a fiber coupler.

In some embodiments, the optical fiber may comprise a plurality of optical fibers, and guiding the laser light along the illumination path with the optical fiber coupled to the laser light source may comprise guiding the laser light along a plurality of illumination paths with the plurality of optical fibers to illuminate a plurality of separate areas of the workpiece.

In some embodiments, directing the laser light on the workpiece with the illumination optical assembly may comprise collimating the laser light in the illumination path with a collimation lens; homogenizing the laser light in the illumination path with a homogenizer; and directing the laser light onto the workpiece with an objective lens.

In some embodiments, separating the fluorescent light from the laser light in the emission path with the collection optical assembly may comprise directing the fluorescent light toward the detector with a beam splitter; and directing the reflected laser light away from the detector with the beam splitter.

In some embodiments, separating the fluorescent light from the laser light in the emission path with the collection optical assembly may comprise transmitting one or more wavelength bands corresponding to the fluorescent light with a spectral filter; and blocking one or more wavelength bands corresponding to the reflected laser light with the spectral filter.

### DESCRIPTION OF THE DRAWINGS

For a fuller understanding of the nature and objects of the disclosure, reference should be made to the following detailed description taken in conjunction with the accompanying drawings, in which:

FIG. 1 is a schematic diagram of a system according to an embodiment of the present disclosure;

FIG. 2 is a section view of an exemplary workpiece according to embodiments of the present disclosure;

FIG. 3 is a section view of an exemplary optical fiber according to embodiments of the present disclosure;

FIG. 4 is a schematic diagram of two laser light sources connected to a single optical fiber according to embodiments of the present disclosure;

FIG. 5 is a schematic diagram of a single laser light source connected to a plurality of optical fibers according to embodiments of the present disclosure;

FIG. 6 is a schematic diagram of a system according to another embodiment of the present disclosure;

FIG. 7 is a schematic diagram of a system according to another embodiment of the present disclosure;

FIG. 8 is a flowchart of a method according to an embodiment of the present disclosure;

FIG. 9 is a flowchart of a method according to an embodiment of the present disclosure;

FIG. 10 is a flowchart of a method according to an embodiment of the present disclosure;

FIG. 11 is a flowchart of a method according to an embodiment of the present disclosure; and

FIG. 12 is a flowchart of a method according to an embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

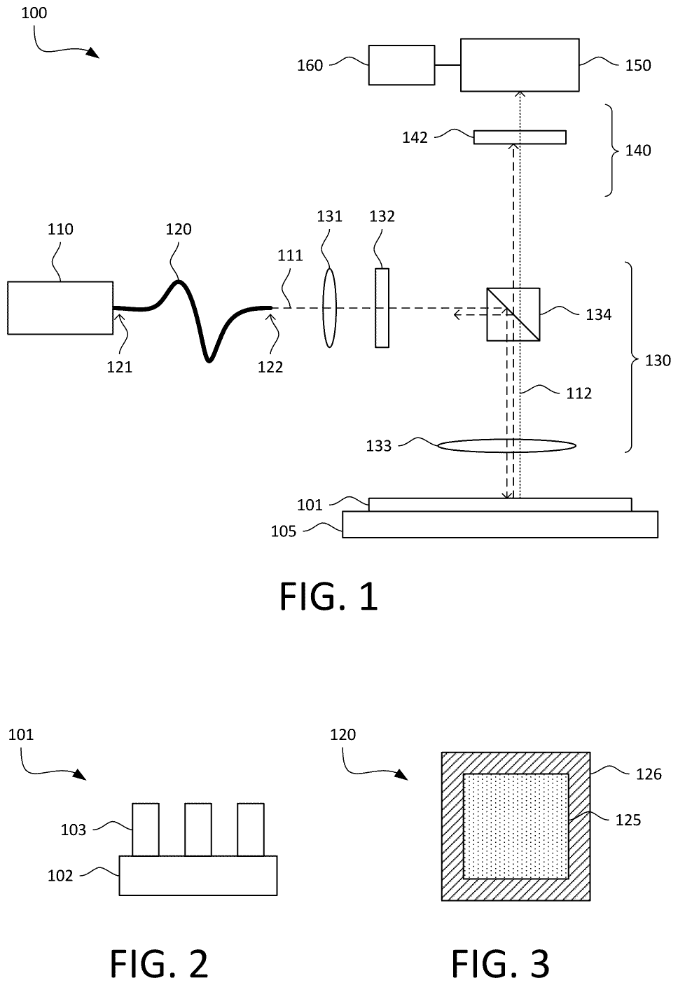

Referring to FIG. 1, an embodiment of the present disclosure provides a system 100. The system 100 may be an inspection system configured to detect defects in a workpiece 101. As used herein, the workpiece 101 may be a semiconductor front-end or back-end wafer, substrate, redistribution layer, panel, or another surface sought to be inspected for defect detection. In some embodiments, the workpiece 101 may comprise a substrate 102 comprising one or more high aspect ratio structures 103, as shown in FIG. 2. For example, the high aspect ratio structures 103 may have a height to width ratio greater than 1:1. In some instances, the height to width ratio may be at least 2:1, or as large as 10:1. High aspect ratio structures 103 may cause attenuation of light reaching the substrate 102 from certain angles. For example, a height to width ratio of 1:1 may cause attenuation of incident light that is less than 45° from the substrate 102, a height to width ratio of 2:1 may cause attenuation of incident light that is less than 63° from the substrate 102, and a height to width ratio of 10:1 may cause attenuation of incident light that is less than 84° from the substrate 102. Accordingly, the height to width ratio of the high aspect ratio structures 103 may limit light that is perpendicular (or within an angular range relative to the normal) to reach the substrate 102. The workpiece 101 may be disposed on a support 105. The support 105 may be a stage having at least two degrees of freedom. For example, the support 105 may be configured to move in two in-plane directions (e.g., x-y directions). The support 105 may be further configured to rotate and/or move in an out-of-plane direction (e.g., z direction). The support 105 may be movable by one or more actuators or other means and is not limited herein. Alternatively, other components of the system 100 may move relative to the support 105.

The system 100 may comprise a laser light source 110. For example, the laser light source 110 may be a laser having a power of 1 mW to 500 W. The laser light source 110 may be configured to emit laser light. The laser light source 110 may be configured to emit the laser light continuously and/or in a pulsed mode. A strong laser pulse can provide the same energy as a continuous laser and may shorten imaging time. However, in some instances, a continuous laser can avoid possible damage to the substrate from strong laser pulses or saturated fluorescence from the high peak power of a strong laser pulse. Alternatively, many weak laser pulses can be used to shorten imaging time compared to a continuous laser and avoid the damage or saturation from a strong laser pulse. The laser light may have a wavelength of 350 nm to 450 nm. The particular parameters of the laser light source 110 may be configured based on the particular application, to set the power, energy, wavelength, and beam size for detecting defects on the workpiece 101.

The system 100 may further comprise an optical fiber 120 having either circular or square shape with core dimensions of 200 to 500 microns. For example, the optical fiber 120 may be a square fiber with 375 μm×375 μm core dimensions. The optical fiber 120 may comprise an input end 121 and an output end 122. The optical fiber 120 may be coupled to the laser light source 110. For example, the input end 121 of the optical fiber 120 may be coupled to the laser light source 110. Accordingly, the laser light emitted by the laser light source 110 may travel through the optical fiber 120. The optical fiber 120 may be flexible, so as to guide the laser light along a nonlinear (i.e., curved) illumination path 111. It should be understood that a high-power laser light source 110 may have a large size that limits its placement and configuration within the system 100. The optical fiber 120 may provide a discrete pathway for the laser light to travel within the system 100, to avoid the space limitations of the laser light source 110. It should also be understood that a high-power laser light source 110 may generate heat and vibrations that could affect other components of the system 100 and may affect stability and accuracy of the system 100. The length of the optical fiber 120 may allow the laser light source 110 to be separated from the other components of the system 100. In other words, the optical fiber 120 may spatially separate the laser light source 110 from the workpiece 101 and the other components of the system 100. This may improve heat flow ventilation around the laser light source 110, avoid volume constraints in the optical system, and reduce the transfer of vibrations from laser source 110 into system 100.

The cross section of the optical fiber 120 may be non-circular, as shown in FIG. 3. For example, the optical fiber 120 may have a cross section that is square, rectangular, oval, or other non-circular shapes. Such a non-circular fiber may scramble the laser light as it travels through the optical fiber 120, increasing the homogeneity of laser light impinging on workpiece 101, and may reduce speckle contrast. The optical fiber 120 may comprise a core 125 surrounded by a sheath 126. The sheath 126 may be made of a flexible material such as metal or plastic, so as to comply with the flexibility of the core 125. The sheath may also protect the core 125 from damage, which could affect the way the optical fiber 120 homogenizes the laser light. In some instances, the optical fiber 120 may comprise a fiber bundle comprising a plurality of the optical fibers described herein.

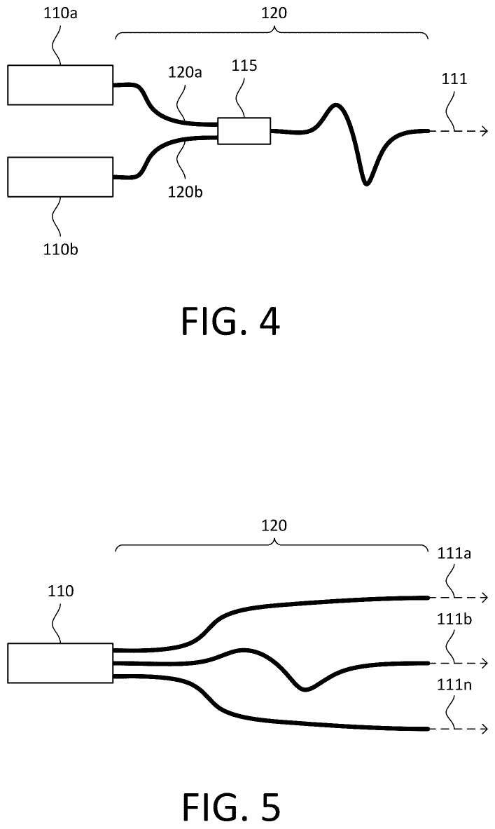

In some embodiments, the system 100 may comprise more than one laser light source 110. For example, as shown in FIG. 4, the system 100 may comprise a first laser light source 110a and a second laser light source 110b. The second laser light source 110b may be configured to emit laser light having at least one different wavelength and a different polarization from the first laser light source 110a. For example, the first laser light source 110a may emit laser light having a wavelength of 395 nm and the second laser light source 110b may emit laser light having a wavelength of 405 nm. The different wavelengths may excite different molecules for use with different types of substrates and can increase the total excitation power. Alternatively, the first laser light source 110a and the second laser light source 110b may emit light having the same wavelength but in orthogonal polarizations, which can increase (or almost double) the output power.

A first optical fiber 120a may be coupled to the first laser light source 110a, and a second optical fiber 120b may be coupled to the second laser light source 110b. A fiber coupler 115 may connect the first optical fiber 120a and the second optical fiber 120b to the input end of the optical fiber 120, and thereby combine the laser light from the first laser light source 110a and the laser light from the second laser light source 110b in a single optical fiber 120 along a common illumination path 111. The fiber coupler 115 may be wavelength selective, e.g., a wavelength division multiplexing (WDM) device, or a polarization-maintaining coupler. The system 100 may comprise additional laser light sources connected to the fiber coupler 115 by respective optical fibers. In some embodiments, a free-space beam combiner can be used to collect the laser light emitted from the first laser light source 110a and the second laser light source 110b without being connected by a first optical fiber 120a and a second optical fiber 120b. In such instances, the free-space beam combiner may combine the collected laser light from the first laser light source 110a and the laser light from the second laser light source 110b in a single optical fiber 120 along a common illumination path 111. The laser light sources may be selected based on their wavelength for use in a particular application to detect defects on a workpiece 101. By combining laser light of different wavelengths from more than one laser light source 110, the workpiece 101 may be illuminated with several wavelengths, which may improve fluorescence emission and quality of the fluorescence image. The first laser light source 110a and the second laser light source 110b may be switched on and off to select which wavelengths of light are used to illuminate the workpiece 101. In some embodiments, laser light from one of the first laser light source 110a and the second laser light source 110b may be used to illuminate a portion of the workpiece 101, and laser light from the other of the first laser light source 110a and the second laser light source 110b (or both) may be used to illuminate other portions of the workpiece 101.

In some embodiments, the system 100 may comprise a plurality of optical fibers 120. For example, as shown in FIG. 5, each optical fiber of the plurality of optical fibers 120 may be coupled to the laser light source 110, and may be configured to guide the laser light along a plurality of illumination paths 111. In some embodiments, there may be n illumination paths (where n≥2), including a first illumination path 111a, a second illumination path 111b, etc., to an nth illumination path 111n. Because each optical fiber 120 is flexible, each of the plurality of illumination paths 111 may diverge in nonlinear directions. Accordingly, the plurality of illumination paths 111 may be configured to illuminate separate areas of the workpiece 101 or separate workpieces 101. The separate areas may be contiguous or non-contiguous.

In some embodiments, the system 100 may comprise a plurality of laser light sources 110 and a plurality of optical fibers 120, i.e., a combination of the examples shown in FIG. 4 and FIG. 5, and is not limited herein. In an instance, the system 100 may not include a fiber coupler 115, and the first optical fiber 120a and the second optical fiber 120b form a fiber bundle that defines of the plurality of optical fibers 120 that guide the laser light along the plurality of illumination paths 111. Alternatively, a plurality of optical fibers 120 connected to a single laser light source 110 may form a fiber bundle.

The system 100 may further comprise an illumination optical assembly 130. The illumination optical assembly 130 may be disposed in the illumination path 111. For example, after the laser light is guided through the optical fiber 120, it may pass through the illumination optical assembly 130. The illumination optical assembly 130 may be configured to direct the laser light on the workpiece 101. The laser light may be focused on the workpiece 101 or the workpiece 101 may be out of focus. The illumination optical assembly 130 may comprise one or more optical elements, such as lenses, beam splitters, mirrors, filters etc. In embodiments where there are a plurality of optical fibers 120, the illumination optical assembly 130 may include one or more optical elements in each of the n illumination paths configured to direct the laser light onto the separate areas of the workpiece 101.

In some embodiments, the illumination optical assembly 130 may comprise a collimation lens 131. The collimation lens 131 may be coupled to an output end of the optical fiber 120. The collimation lens 131 may be configured to collimate the laser light in the illumination path 111 after it has passed through the optical fiber 120.

The illumination optical assembly 130 may further comprise a homogenizer 132. The homogenizer 132 may be disposed in the illumination path 111 downstream of the collimation lens 131. The homogenizer 132 may be configured to homogenize the laser light in the illumination path 111. In some embodiments, the homogenizer 132 may comprise a micro lens array.

The illumination optical assembly 130 may further comprise an objective lens 133. The objective lens 133 may be disposed in the illumination path 111 downstream of the homogenizer 132. The objective lens 133 may be configured to direct the laser light onto the workpiece 101. As used herein, the term “objective lens” refers to a lens that is close to the workpiece 101 and is used for imaging the workpiece 101, but is not limited to a particular type of lens. The area of the workpiece 101 illuminated by the laser light may depend on the field of view of the objective lens 133. For example, the laser-illuminated region on the workpiece 101 may be about 1 mm by 1 mm in size.

The illumination optical assembly 130 may further comprise a first beam splitter 134. The first beam splitter 134 may be disposed in the illumination path 111 upstream of the objective lens 133. The first beam splitter 134 may be configured to direct the laser light toward the objective lens 133.

The illumination optical assembly 130 may comprise any other optical elements. Examples of such optical elements include, but are not limited to, polarizing component(s), spectral filter(s), spatial filter(s), refractive optical element(s), reflective optical element(s), diffractive optical elements, apodizer(s), beam splitter(s), aperture(s), and the like, which may include any such suitable optical elements known in the art.

The illumination from the laser light may be perpendicular to the workpiece 101. For example, the optical fiber 120 may guide the illumination path 111 to be perpendicular to the workpiece 101 and/or the illumination optical assembly 130 may direct the laser light onto the workpiece 101 in a direction perpendicular to the workpiece 101. It should be understood that the illumination from the laser light may be substantially perpendicular to the workpiece 101, e.g., ±45°, ±27°, or ±6° from the direction normal to the workpiece 101, the angular range being limited by the height to with ratio of the high aspect ratio structures 103 of the workpiece 101. Accordingly, for a workpiece 101 comprising a substrate 102 and one or more high aspect ratio structures 103, the laser light will directly illuminate the substrate 102 between HAR structures 103 for improved illumination compared to light being directed from other angles.

Based on the illumination from the laser light, the workpiece 101 may fluoresce, thereby emitting fluorescent light along an emission path 112. The fluorescent light will be at longer wavelengths than the laser wavelength, depending on laser wavelength and substrate composition and structure; for example the fluorescence spectrum may be 400 nm to 650 nm. While the illumination path 111 is configured such that the illumination from the laser light is perpendicular to the workpiece 101, the fluorescent light may be emitted away from the workpiece 101 at a wide angular range, centered along the emission path 112 that may be perpendicular to the workpiece 101. Accordingly, the emission path 112 refers to the direction at which the fluorescence will be observed, and may or may not be the direction which the fluorescence is the strongest. It should be understood that illumination from the laser light may also cause laser light to be reflected by the workpiece 101. Accordingly, the emission path 112 may comprise both reflected laser light and fluorescent light. The first beam splitter 134 may be disposed in the emission path, such that some of the reflected laser light may be redirected by the first beam splitter 134, while the remaining reflected laser light and the fluorescent light may be transmitted through the first beam splitter 134 along the emission path 112.

The system 100 may further comprise a collection optical assembly 140. The collection optical assembly 140 may be disposed in the emission path 112. For example, after the fluorescent light is emitted from the workpiece 101 and the laser light is reflected by the workpiece 101, the fluorescent light and the reflected laser light may pass through the collection optical assembly 140. The collection optical assembly 140 may be configured to separate the fluorescent light from the reflected laser light. For example, the fluorescent light and the reflected laser light may have different wavelengths, and the collection optical assembly 140 may be configured to separate the fluorescent light from the reflected laser light based on their different wavelengths. The collection optical assembly 140 may comprise one or more optical elements, such as lenses, beam splitters, mirrors, filters etc.

The system 100 may further comprise a detector 150, for example a charge-coupled device (CCD) or a complementary metal oxide semiconductor (CMOS) based camera. The detector 150 may be disposed in the emission path 112, downstream of the collection optical assembly 140. The detector 150 may be configured to generate one or more fluorescence images based on the fluorescent light. For example, after the collection optical assembly 140 separates the fluorescent light from the reflected laser light, the fluorescent light may be directed to the detector 150. Accordingly, the bright reflected laser light will not overshadow the fluorescent light signal, and thereby may result in a sharper, high contrast fluorescence image. In some embodiments, there may be a time delay between the time when the laser source 110 is triggered to illuminate the workpiece 101 and the time when the detector 150 is triggered to capture an image. For example, the detector 150 may be triggered to capture an image after the laser source 110 is turned off. Accordingly, the fluorescent light emitted from the workpiece 101 may persist longer the reflected laser light, such that less reflected laser light may need to be separated from the emission path 112 before reaching the detector 150.

In some embodiments, the collection optical assembly 140 may comprise a spectral filter 142, as shown in FIG. 1. The spectral filter 142 may be disposed in the emission path 112 upstream of the detector 150. The spectral filter 142 may be a notch filter, a long-pass filter, or other type of filter. The spectral filter 142 may be configured to transmit one or more wavelength bands corresponding to the fluorescent light and block one or more wavelength bands corresponding to the reflected laser light. For example, the spectral filter 142 may have a cut-on wavelength of 450 nm. Accordingly, the spectral filter 142 may prevent bright laser light outside of the fluorescent wavelength bands from reaching the detector 150.

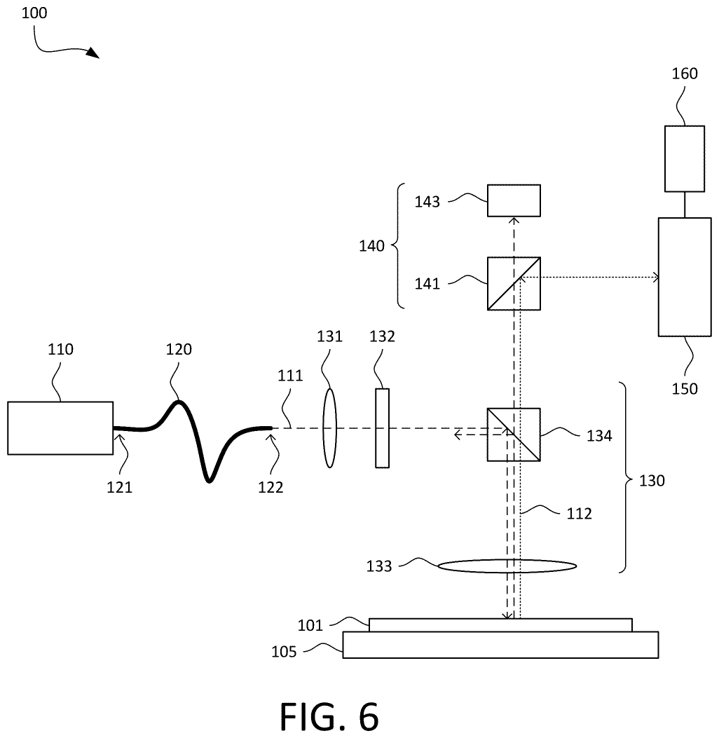

In some embodiments, the collection optical assembly 140 may comprise a second beam splitter 141, as shown in FIG. 6. The second beam splitter 141 may be disposed in the emission path 112 between the workpiece 101 and the detector 150. The second beam splitter 141 may be configured to direct the fluorescent light toward the detector 150 and direct the reflected laser light away from the detector 150. For example, the second beam splitter 141 may be configured to reflect a wavelength band corresponding to one of the fluorescent light or the reflected laser light, and the second beam splitter 141 may be further configured to transmit remaining wavelengths. Accordingly, the fluorescent light may be separated from the reflected laser light by selectively reflecting/transmitting wavelength bands. The second beam splitter 141 may direct the reflected laser light to a beam dump 143. In some instances, the fluorescent light from a highly-fluorescent substrate may produce a high contrast fluorescence image with only the second beam splitter 141 (i.e., without the use of a spectral filter 142).

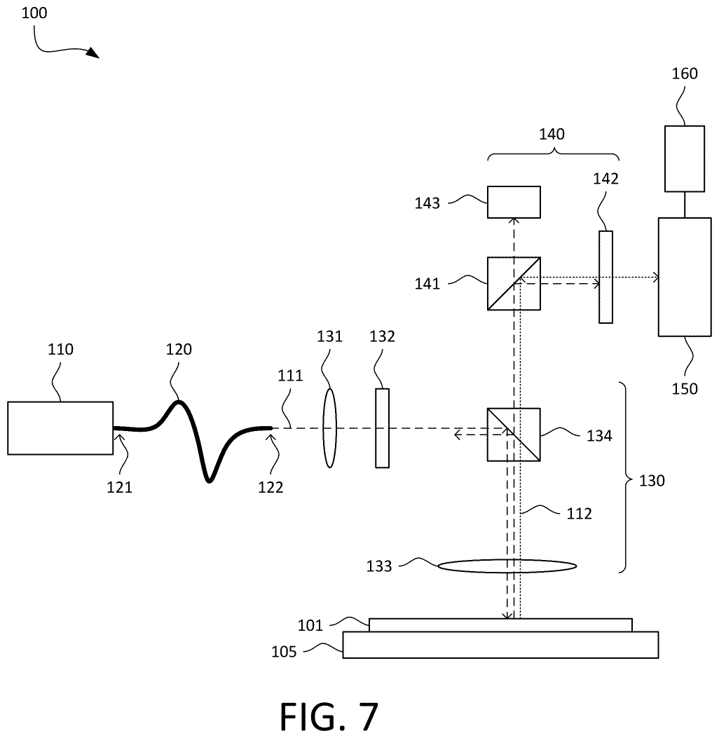

In some embodiments, the collection optical assembly 140 may comprise both a second beam splitter 141 and a spectral filter 142, as shown in FIG. 7. The spectral filter 142 may be disposed in the emission path 112 between the second beam splitter 141 and detector 150. It should be understood that the spectral filter 142 may more strongly attenuate reflected laser light compared to the second beam splitter 141. Accordingly, the detector 150 may receive a clearer fluorescent light band that can be used to produce a sharper, high contrast fluorescence image.

The collection optical assembly 140 may comprise any other optical elements. Examples of such optical elements include, but are not limited to, polarizing component(s), spectral filter(s), spatial filter(s), reflective optical element(s), refractive optical element(s), diffractive optical element(s), apodizer(s), beam splitter(s), aperture(s), and the like, which may include any such suitable optical elements known in the art.

The system 100 may further comprise a processor 160. The processor 160 may include a microprocessor, a microcontroller, or other devices.

The processor 160 may be coupled to the components of the system 100 in any suitable manner (e.g., via one or more transmission media, which may include wired and/or wireless transmission media) such that the processor 160 can receive output. The processor 160 may be configured to perform a number of functions using the output. An inspection tool can receive instructions or other information from the processor 160. The processor 160 optionally may be in electronic communication with another inspection tool, a metrology tool, a repair tool, or a review tool (not illustrated) to receive additional information or send instructions.

The processor 160 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 160 may be disposed in or otherwise part of the system 100 or another device. In an example, the processor 160 and may be part of a standalone control unit or in a centralized quality control unit. Multiple processors 160 may be used, defining multiple subsystems of the system 100.

The processor 160 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 160 to implement various methods and functions may be stored in readable storage media, such as a memory.

If the system 100 includes more than one subsystem, then the different processors 160 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 160 may be configured to perform a number of functions using the output of the system 100 or other output. For instance, the processor 160 may be configured to send the output to an electronic data storage unit or another storage medium. The processor 160 may be further configured as described herein.

The processor 160 may be configured according to any of the embodiments described herein. The processor 160 also may be configured to perform other functions or additional steps using the output of the system 100 or using images or data from other sources.

The processor 160 may be communicatively coupled to any of the various components or sub-systems of system 100 in any manner known in the art. Moreover, the processor 160 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 160 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 160 (or computer subsystem) or, alternatively, multiple processors 160 (or multiple computer subsystems). Moreover, different sub-systems of the system 100 may include one or more computing or logic systems. Therefore, the above description should not be interpreted as a limitation on the present disclosure but merely an illustration.

The processor 160 may be in electronic communication with the detector 150. For example, the processor 160 may receive the one or more fluorescence images from the detector 150 by wired or wireless transmission.

The processor 160 may further be in electronic communication with the support 105. For example, the processor 160 may be configured to control the one or more actuators to move the support 105, thereby changing the position where the laser light impinges on the workpiece 101.

The processor 160 may further be in electronic communication with the laser light source 110. For example, the processor 160 may be configured to control the laser light source 110 to emit laser light (e.g., turn on/off) and to adjust parameters of the laser light source 110 to adjust the parameters of the produced laser light (e.g., intensity, wavelength, beam size). In some embodiments, the processor 160 may be configured to independently control the first laser light source 110a, the second laser light source 110b, and any additional laser light sources 110.

With the system 100, fluorescence detection may be improved for substrates having HAR structures. For example, the laser light source 110 can be used to illuminate a large area on the workpiece 101 at a high intensity and homogeneity compared to LEDs that have low power and brightness. The laser light source 110 also emits a narrower spectrum of light compared to LEDs, which is more efficient to separate from emitted fluorescent light. By coupling the laser light source 110 to the optical fiber 120, the laser light source 110 can be separated from the workpiece 101 and the other components of the system 100, which allows for improved management of heat flow and ventilation. As the optical fiber 120 is flexible, the illumination path 111 can be guided within system such that the illumination is coaxial with the optical axis of the objective lens 133 (i.e., perpendicular to the workpiece 101), which can effectively illuminate between HAR structures on the workpiece 101. Furthermore, the collection optical assembly 140 may be configured to separate the fluorescent light from reflected laser light, which allows the detector to acquire a clear fluorescence image having high contrast.

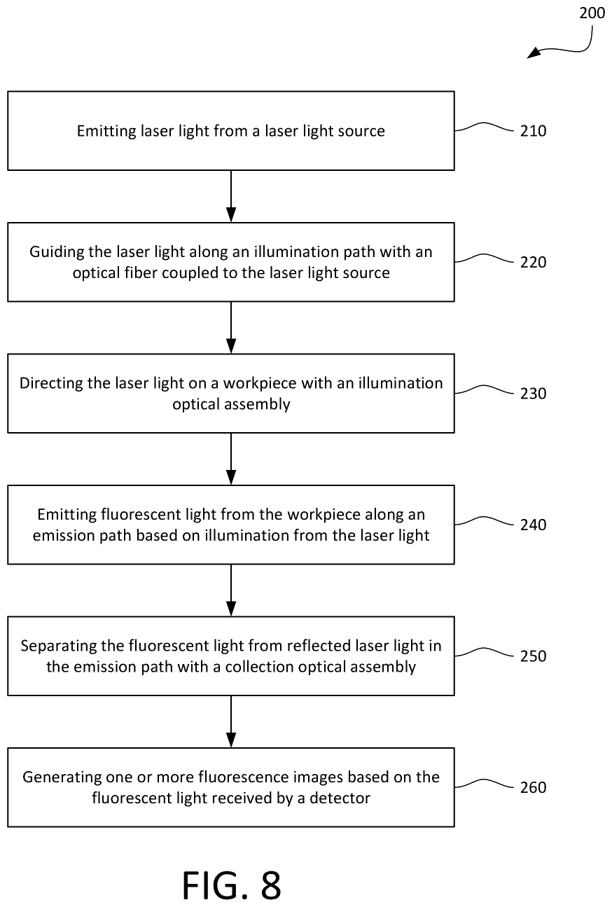

Another embodiment of the present disclosure provides a method 200. The method 200 may be applied to an inspection system configured to detect defects in a workpiece. As used herein, the workpiece may be a semiconductor wafer, substrate, panel, or another surface sought to be inspected for defect detection. In some embodiments, the workpiece may comprise a substrate comprising one or more high aspect ratio structures. As shown in FIG. 8, the method 200 may comprise the following steps.

At step 210, laser light is emitted from a laser light source. For example, the laser light source may be a multimode diode laser having a power of 1 mW to 500 W. The laser light source may be configured to emit laser light along an illumination path. The laser light source may be configured to emit the laser light continuously and/or in a pulsed mode. A strong laser pulse can provide the same energy as a continuous laser and may shorten imaging time. However, in some instances, a continuous laser can avoid possible damage to the substrate from strong laser pulses or saturated fluorescence from the high peak power of a strong laser pulse. Alternatively, many weak laser pulses can be used to shorten imaging time compared to a continuous laser and avoid the damage or saturation from a strong laser pulse. The laser light may have a wavelength of 350 nm to 450 nm. The particular parameters of the laser light source may be configured based on the particular application, to set the power, energy, wavelength, and beam size for detecting defects on the workpiece.

At step 220, the laser light is guided along an illumination path with an optical fiber coupled to the laser light source. For example, an input end of the optical fiber may be coupled to an output end of the laser light source. Accordingly, the laser light emitted by the laser light source may travel through the optical fiber. The optical fiber may be flexible, so as to guide the laser light along a nonlinear (i.e., curved) illumination path. It should be understood that a high-power laser light source may have a large size that limits its placement and configuration within the inspection system. The optical fiber may provide a discrete pathway for the laser light to travel within the inspection system, to avoid the space limitations of the laser light source. It should also be understood that a high-power laser light source may generate heat or vibrations that could affect other components of the inspection system and may affect stability and accuracy of the system. The length of the optical fiber may allow the laser light source to be separated from the other components of the system. In other words, the optical fiber may spatially separate the laser light source from the workpiece and the other components of the system. This may improve heat flow and ventilation around the laser light source.

The optical fiber may have a circular or square shape with core dimensions of 200 to 500 microns. For example, the optical fiber may be a square fiber with 375 μm×375 μm core dimensions. In some embodiments, the optical fiber may be non-circular. Such a non-circular fiber may scramble the laser light as it travels through the optical fiber, increasing the homogeneity of the laser light impinging on a workpiece. The optical fiber may comprise a core surrounded by a sheath. The sheath may be made of a flexible material such as metal or plastic, so as to comply with the flexibility of the core. The sheath may also protect the core from damage, which could affect the way the optical fiber homogenizes the laser light. In some instances, the optical fiber may comprise a fiber bundle comprising a plurality of optical fibers.

At step 230, the laser light is directed on a workpiece with an illumination optical assembly. For example, after the laser light is guided through the optical fiber, it may pass through the illumination optical assembly. The laser light may be focused on the workpiece or the workpiece may be out of focus. The illumination optical assembly may comprise one or more optical elements, such as lenses, beam splitters, mirrors, filters etc. The area of the workpiece illuminated by the laser light may depend on the field of view of an objective lens. For example, the laser-illuminated region on the workpiece may be about 1 mm by 1 mm in size.

The illumination from the laser light may be perpendicular to the workpiece. For example, the optical fiber may guide the illumination path to be perpendicular to the workpiece and/or the illumination optical assembly may direct the laser light onto the workpiece in a direction perpendicular to the workpiece. It should be understood that the illumination from the laser light may be substantially perpendicular to the workpiece, e.g., ±45°, ±27°, or ±6° from the direction normal to the workpiece, the angular range being limited by the height to with ratio of the high aspect ratio structures of the workpiece. Accordingly, for a workpiece comprising a substrate and one or more high aspect ratio structures, the laser light will directly illuminate the substrate between HAR structures for improved illumination compared to light being directed from other angles.

At step 240, fluorescent light is emitted from the workpiece along an emission path based on illumination from the laser light. The fluorescent light will be at longer wavelengths than the laser wavelength, depending on the laser wavelength and substrate composition and structure; for example, the fluorescence spectrum may be 400 nm to 650 nm. While the illumination path is configured such that the illumination from the laser light is perpendicular to the workpiece, the fluorescent light may be emitted away from the workpiece at a wide angular range, centered along the emission path that may be perpendicular to the workpiece. Accordingly, the emission path refers to the direction at which the fluorescence will be observed, and may or may not be the direction which the fluorescence is the strongest. It should be understood that illumination from the laser light may also cause laser light to be reflected by the workpiece. Accordingly, the emission path may comprise both reflected laser light and fluorescent light.

At step 250, the fluorescent light is separated from reflected laser light in the emission path with a collection optical assembly. For example, after the fluorescent light is emitted from the workpiece and the laser light is reflected by the workpiece, the fluorescent light and the reflected laser light may pass through the collection optical assembly. In some embodiments, the fluorescent light and the reflected laser light may have different wavelengths, and the collection optical assembly may be configured to separate the fluorescent light from the reflected laser light based on their different wavelengths. The collection optical assembly may comprise one or more optical elements, such as lenses, beam splitters, mirrors, filters etc.

At step 260, one or more fluorescence images are generated based on the fluorescent light received by a detector, for example, charge-coupled device (CCD) or a complementary metal oxide semiconductor (CMOS) based camera. After the collection optical assembly separates the fluorescent light from the reflected laser light, the fluorescent light may be directed to the detector. Accordingly, the bright reflected laser light will not overshadow the fluorescent light signal, and thereby may result in a sharper, high contrast fluorescence image. In some embodiments, there may be a time delay between the time when the laser source is triggered to illuminate the workpiece and the time when the detector is triggered to capture an image. For example, the detector may be triggered to capture an image after the laser source is turned off, after a delay of less than 1 μs. Accordingly, the fluorescent light emitted from the workpiece may persist longer the reflected laser light, such that less reflected laser light may need to be separated from the emission path before reaching the detector, or that no filters or beam splitters are needed to separate the light.

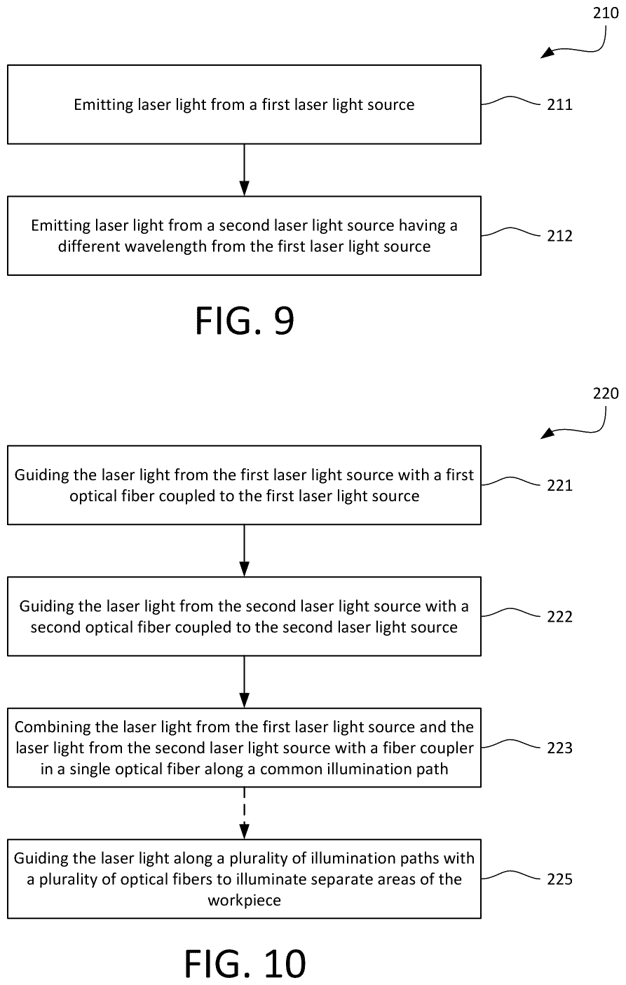

In some embodiments, more than one laser light source may be used. As shown in FIG. 9, step 210 may comprise the following steps.

At step 211, laser light is emitted from a first laser light source.

At step 212, laser light is emitted from a second laser light source having at lease one different wavelength and a different polarization from the first laser light source. For example, the first laser light source may emit laser light having a wavelength of 395 nm and the second laser light source may emit laser light having a wavelength of 405 nm. The different wavelengths may excite different molecules for use with different types of substrates and can increase the total excitation power. Alternatively, the first laser light source and the second laser light source may emit light having the same wavelength but in orthogonal polarizations, which can increase (or almost double) the output power.

While FIG. 9 illustrates step 212 being performed after step 211, it should be understood that step 212 may be performed in parallel with step 211 or prior to step 211 and is not limited herein.

Each laser light source may be coupled to its own optical fiber. As shown in FIG. 10, step 220 may comprise the following steps.

At step 221, the laser light is guided from the first laser light source with a first optical fiber coupled to the first laser light source.

At step 222, the laser light is guided from the second laser light source with a second optical fiber coupled to the second laser light source.

At step 223, the laser light exiting the first optical fiber and the laser light exiting the second optical fiber are combined in a single optical fiber along a common illumination path with a fiber coupler. The fiber coupler may be wavelength selective, e.g., a wavelength division multiplexing (WDM) device.

Additional laser light sources may be connected to the fiber coupler by respective optical fibers. The laser light sources may be selected based on their wavelength for use in a particular application to detect defects on a workpiece. By combining laser light of different wavelengths from more than one laser light source, the workpiece may be illuminated with several wavelengths, which may improve fluorescence emission and quality of the fluorescence image. The first laser light source and the second laser light source may be switched on and off to select which wavelengths of light are used to illuminate the workpiece. In some embodiments, laser light from one of the first laser light source and the second laser light source may be used to illuminate a portion of the workpiece, and laser light from the other of the first laser light source and the second laser light source (or both) may be used to illuminate other portions of the workpiece.

In some embodiments, the optical fiber may comprise a plurality of optical fibers. As shown in FIG. 10, step 220 may further comprise the following.

At step 225, the laser light is guided along a plurality of illumination paths with the plurality of optical fibers to illuminate a plurality of separate areas of the workpiece. Because each optical fiber is flexible, each of the plurality of illumination paths may diverge in nonlinear directions. Accordingly, the plurality of illumination paths may be configured to illuminate separate areas of the workpiece or separate workpieces. The separate areas may be contiguous or non-contiguous.

In some embodiments, step 225 may be performed after step 223 described above. In other words, after the laser light from the first and second laser light sources is combined with the fiber coupler, the plurality of optical fibers may guide the laser light along the plurality of illumination paths. Alternatively, step 225 may be performed without steps 221-223. In other words, laser light from a single laser light source may be guided by the plurality of optical fibers along the plurality of illumination paths.

In some embodiments, step 225 may be performed without step 223 described above. In other words, the first and second optical fiber guide the laser light from the first laser light source and the laser light from the second laser light source along separate illumination paths. These optical fibers may be combined into a fiber bundle.

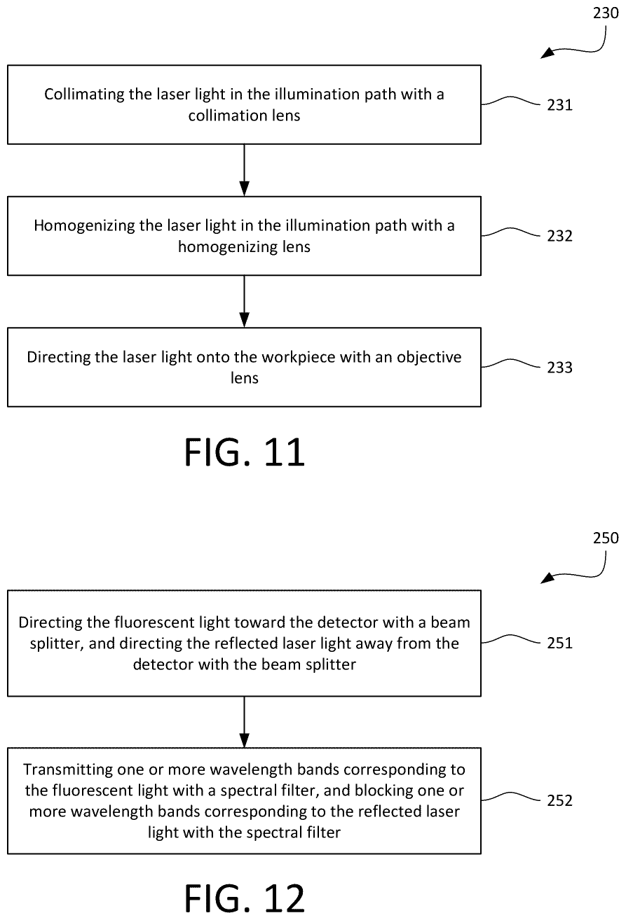

In some embodiments, step 230 may comprise the following steps shown in FIG. 11.

At step 231, the laser light in the illumination path is collimated with a collimation lens. The collimation lens may be coupled to an output end of the optical fiber.

At step 232, the laser light in the illumination path is homogenized with a homogenizer. The homogenizer may be disposed in the illumination path downstream of the collimation lens. In some embodiments, the homogenizer may comprise a micro lens array.

At step 233, the laser light is directed onto the workpiece with an objective lens. The objective lens may be disposed in the illumination path downstream of the homogenizer.

In some embodiments, step 250 may comprise the following steps shown in FIG. 12.

At step 251, the fluorescent light is directed toward the detector with a beam splitter, and the reflected laser light is directed away from the detector with the beam splitter. For example, the beam splitter may be configured to reflect a wavelength band corresponding to one of the fluorescent light or the reflected laser light, and the beam splitter may be further configured to transmit remaining wavelengths. Accordingly, the fluorescent light may be separated from the reflected laser light by selectively reflecting/transmitting wavelengths bands.

At step 252, one or more wavelength bands corresponding to the fluorescent light are transmitted with a spectral filter, and one or more wavelength bands corresponding to the reflected laser light are blocked with the spectral filter. It should be understood that the spectral filter may more strongly attenuate reflected laser light compared to the beam splitter. Accordingly, the detector may receive a clearer fluorescent light band that can be used to produce a sharper, high contrast fluorescence image.

With the method 200, fluorescence detection may be improved for substrates having HAR structures. For example, the laser light source can be used to illuminate a large area on the workpiece at a high intensity and homogeneity compared to LEDs that have low power and brightness. By coupling the laser light source to the optical fiber, the laser light source can be separated from the workpiece and the other components of the system, which allows for improved management of heat flow and ventilation. As the optical fiber is flexible, the illumination path can be guided within system such that the illumination is coaxial with the optical axis of the objective lens (i.e., perpendicular to the workpiece), which can effectively illuminate between HAR structures on the workpiece. Furthermore, the collection optical assembly may be configured to separate the fluorescent light from reflected laser light, which allows the detector to acquire a clear fluorescence image having high contrast.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a laser light source configured to emit laser light;
an optical fiber coupled to the laser light source and configured to guide the laser light along an illumination path;
an illumination optical assembly disposed in the illumination path and configured to direct the laser light on a workpiece, wherein the workpiece emits fluorescent light along an emission path based on illumination from the laser light;
a collection optical assembly disposed in the emission path and configured to separate the fluorescent light from reflected laser light; and
a detector disposed in the emission path and configured to generate one or more fluorescence images based on the fluorescent light.

2. The system of claim 1, wherein the illumination from the laser light is perpendicular to the workpiece.

3. The system of claim 1, wherein the laser light source has a power of 1 mW to 500 W.

4. The system of claim 1, wherein the laser light source is a first laser light source, and the system further comprises:
a second laser light source configured to emit laser light having at least one different wavelength and a different polarization from the first laser light source; and
a fiber coupler configured to combine the laser light from the first laser light source and the laser light from the second laser light source in a single optical fiber along a common illumination path.

5. The system of claim 1, wherein the optical fiber comprises a plurality of optical fibers, each optical fiber is configured to guide the laser light along separate illumination paths, and the illumination optical assembly is configured to direct the laser light in each of the separate illumination paths to illuminate separate areas of the workpiece.

6. The system of claim 1, wherein the optical fiber is a non-circular optical fiber.

7. The system of claim 1, wherein the illumination optical assembly comprises:
a collimation lens configured to collimate the laser light in the illumination path;
a homogenizer configured to homogenize the laser light in the illumination path; and
an objective lens configured to direct the laser light onto the workpiece.

8. The system of claim 1, wherein the collection optical assembly comprises:
a beam splitter disposed in the emission path and configured to direct the fluorescent light toward the detector and direct the reflected laser light away from the detector.

9. The system of claim 1, wherein the collection optical assembly comprises:
a spectral filter disposed in the emission path and configured to transmit one or more wavelength bands corresponding to the fluorescent light and block one or more wavelength bands corresponding to the reflected laser light.

10. The system of claim 1, wherein the laser light has a wavelength of 350 nm to 450 nm.

11. The system of claim 1, wherein the fluorescent light has a wavelength of 400 nm to 650 nm.

12. The system of claim 1, wherein the workpiece is a substrate comprising one or more structures having an aspect ratio greater than 1:1.

13. The system of claim 1, wherein the laser light source is spatially separated from the illumination optical assembly by the optical fiber.

14. A method comprising:
emitting laser light from a laser light source;
guiding the laser light along an illumination path with an optical fiber coupled to the laser light source;
directing the laser light on a workpiece with an illumination optical assembly;
emitting fluorescent light from the workpiece along an emission path based on illumination from the laser light;
separating the fluorescent light from reflected laser light in the emission path with a collection optical assembly; and
generating one or more fluorescence images based on the fluorescent light received by a detector.

15. The method of claim 14, wherein the illumination from the laser light is perpendicular to the workpiece.

16. The method of claim 14, wherein:
emitting laser light from the laser light source comprises:
emitting laser light from a first laser light source; and
emitting laser light from a second laser light source having at least one different wavelength and a different polarization from the first laser light source; and
guiding the laser light along the illumination path with the optical fiber coupled to the laser light source comprises:
guiding the laser light from the first laser light source with a first optical fiber coupled to the first laser light source;
guiding the laser light from the second laser light source with a second optical fiber coupled to the second laser light source; and
combining the laser light from the first laser light source of the first optical fiber and the laser light from the second laser light source of the second optical fiber in a single optical fiber along a common illumination path with a fiber coupler.

17. The method of claim 14, wherein the optical fiber comprises a plurality of optical fibers, and guiding the laser light along the illumination path with the optical fiber coupled to the laser light source comprises:
guiding the laser light along a plurality of illumination paths with the plurality of optical fibers to illuminate a plurality of separate areas of the workpiece.

18. The method of claim 14, wherein directing the laser light on the workpiece with the illumination optical assembly comprises:
collimating the laser light in the illumination path with a collimation lens;
homogenizing the laser light in the illumination path with a homogenizer; and
directing the laser light onto the workpiece with an objective lens.

19. The method of claim 14, wherein separating the fluorescent light from the laser light in the emission path with the collection optical assembly comprises:
directing the fluorescent light toward the detector with a beam splitter; and
directing the reflected laser light away from the detector with the beam splitter.

20. The method of claim 14, wherein separating the fluorescent light from the laser light in the emission path with the collection optical assembly comprises:
transmitting one or more wavelength bands corresponding to the fluorescent light with a spectral filter; and
blocking one or more wavelength bands corresponding to the reflected laser light with the spectral filter.
